(19) United States
(12) Patent Application Publication
(10) Pub. No.: US 2004/0004777 A1
(43) Pub. Date: Jan. 8, 2004

(54) Semipermeable reflecting film

(76) Inventor: Keita Takehisa, Kanagawa (JP)

Correspondence Address: SUGHRUE MION, PLLC, 2100 PENNSYLVANIA AVENUE, N.W., WASHINGTON, DC, 20037, US

(21) Appl. No.: 10/363,780

(22) PCT Filed: Jun. 4, 2002
(86) PCT No.: PCT/JP02/05484

(30) Foreign Application Priority Data
Jun. 4, 2001 (JP) 2001-167869
Jun. 25, 2001 (JP) 2001-191059
Jun. 25, 2001 (JP) 2001-191060

(51) Int. Cl. G02F 1/1335; G02B 5/08; G02B 7/182

(52) U.S. Cl. 359/883

(57) ABSTRACT

A semi-transmitting reflection film having good visibility with both transmitting light and reflecting light is produced by using a semi-transmitting reflection film having a semi-transmitting reflection layer containing a pearlescent pigment and formed on at least one surface of a plastic film provided that the pearlescent pigment in the semi-transmitting reflection layer is oriented at an orientation angle of 15 degrees or smaller relative to the plane of the plastic film, the average particle diameter of the pearlescent pigment in the semi-transmitting reflection layer is from 3 to 60 μm and the ratio of the average particle diameter (D) of the pearlescent pigment in the semi-transmitting reflection layer to the thickness (T) of the semi-transmitting reflection layer (D/T) is from 1.3 to 30.

### TECHNICAL FIELD

This invention relates to a semi-transmitting reflection film having semi-transmitting reflecting function, particularly a semi-transmitting reflection film to be used in the light source of a liquid crystal display. This invention further relates to a laminate for liquid crystal display.

### BACKGROUND ARTS

Liquid crystal display has been rapidly prevailed recently as a display for personal computers, car navigation systems, PDA and cell phones owing to the merits of liquid crystal display comprising easy reduction of the thickness and size and small power consumption. However, light transmitting from the side opposite to the viewing side of a liquid crystal cell is necessary for liquid crystal display for viewing the display. The necessity in the light source for the recognition of a liquid crystal display is a factor to restrict the service time of a portable electronic device although the liquid crystal display is a power saving display.

Semi-transmitting reflection liquid crystal displays were developed to solve the problem. A semi-transmitting reflection-type liquid crystal display shows the display by reflection light of outside light when the surrounding environment is light and shows by transmitting light using the built-in light source when the environment is dark.

However, it is extremely difficult even by a semi-transmitting reflection-type liquid crystal display to secure sufficient visibility both in the display with reflecting light and in the display with transmitting light because the visibility with transmitting light is remarkably decreased by sufficiently increasing the visibility with reflecting light and, conversely, the visibility with reflecting light becomes extremely poor by sufficiently increasing the visibility with transmitting light.

The use of a semi-transmitting reflection layer containing a pearlescent pigment (plate mica particles coated with titanium dioxide) has been proposed as a means for getting good visibility with both transmitting light and reflecting light, however, good visibility with both transmitting light and reflecting light is unattainable by the simple compounding of a pearlescent pigment.

Another method for getting good visibility with both transmitting light and reflecting light is the application of shearing force to a coating liquid layer to form the semi-transmitting reflection layer. It is necessary in this method to adjust the shear rate between a thickness controlling member and the coating liquid layer or the shear rate between a coating liquid supplying member and the sheet to be coated and, accordingly, the appearance of the obtained semi-transmitting reflection film varies with the coating speed and shear rate and the production of a semi-transmitting reflection film having good appearance is difficult.

### DISCLOSURE OF THE INVENTION

The first object of the invention is to provide a semi-transmitting reflection film capable of ensuring sufficient visibility of a display with both reflecting light and transmitting light and developing excellent visibility with both reflecting light and transmitting light in the case of using the film in a liquid crystal display.

The second object of the invention is to provide a semi-transmitting reflection film having excellent surface appearance, especially texture and suitably usable as a liquid crystal display.

The third object of the invention is to provide a semi-transmitting reflection film having excellent scratch resistance in the production process.

The fourth object of the invention is to provide a semi-transmitting reflection film having excellent visibility with both transmitting light and reflecting light independent of the shearing force of the coating liquid to be used for the coating of the semi-transmitting reflection layer.

The present invention discloses a semi-transmitting reflection film having a semi-transmitting reflection layer containing a pearlescent pigment on at least one surface of a plastic film, wherein the pearlescent pigment in the semi-transmitting reflection layer is oriented at an orientation angle of 15 degrees or below relative to the plane of the plastic film, the average particle diameter of the pearlescent pigment in the semi-transmitting reflection layer is 3 to 60 μm, and the ratio of the average particle diameter (D) of the pearlescent pigment in the semi-transmitting reflection layer to the thickness (T) of the semi-transmitting reflection layer (D/T) is between 1.3 and 30.

The present invention is further explained in more detail as follows.

(Plastic Film)

Transparent plastic films can be used as the plastic film of the substrate of the present invention. Films of polyesters, polyolefins (polyethylene, polypropylene and the like), polyvinyl chlorides and polycarbonates are cited as examples of the plastic films. Polyester films are especially preferable among the above examples from the viewpoints of mechanical properties and transparency.

In the case of using a polyester film as the plastic film, the polyester is preferably a crystalline linear saturated polyester composed of an aromatic dicarboxylic acid component and a diol component, such as polyethylene terephthalate, polypropylene terephthalate, polybutylene terephthalate and polyethylene-2,6-naphthalenedicarboxylate. Polyethylene terephthalate and polyethylene-2,6-naphthalenedicarboxylate are especially preferable from the viewpoint of transparency.

The polyester may be a homopolymer or a copolymer copolymerized with a copolymer component to an extent not to deteriorate the heat deformation resistance, for example 10% by weight or less, especially 5% by weight or less based on the total repeating units. The polyester may be used in the form of a polymer blend mixed with other organic polymers in an amount of for example 10% by weight or less, especially 5% by weight or less.

The intrinsic viscosity (in o-chlorophenol at 35° C.) of the polyester is preferably from 0.40 to 1.50 dl/g, more preferably from 0.45 to 1.20 dl/g. High productivity can be attained in the raw material production process and the film-forming process while keeping the mechanical properties necessary as a substrate of a semi-transmitting reflection layer by using a polyester having an intrinsic viscosity falling within the above range.

The centerline average height (Ra) of the plastic film, especially the polyester film, is preferably from 15 to 400 nm. When the Ra is smaller than 15 nm, the scratch resistance of the surface of the semi-transmitting reflection film free from the semi-transmitting reflection layer becomes poor to cause the scratch damage in the transportation of the film in stacked state. In a film having an Ra of exceeding 400 nm, the orientation of the pearlescent pigment is sometimes hindered and the transparency of the film is considerably lowered to make difficulty in getting sufficient visibility with transmitting light.

The ten-point-average surface roughness (Rz) of the plastic film, especially polyester film, is preferably from 2,000 to 6,000 nm and the number of protrusions having a height of 0.6 μm or over on the film surface is preferably 100/mm² or more for keeping the handling property of the film and preventing the damage on the film surface.

Such surface can be attained by properly compounding fine particles in a semi-transmitting reflection film. Concrete examples of the fine particle are inorganic fine particles such as silica, alumina, kaolin, calcium carbonate, titanium oxide and barium sulfate and organic fine particles such as crosslinked acrylic resin, crosslinked polystyrene resin, melamine resin and crosslinked silicone resin.

The average particle diameter of the fine particle is preferably from 20 to 5,000 nm, especially from 60 to 3,000 nm to keep the transparency of the film. The addition amount of the fine particle is preferably from 0.1 to 0.5% by weight based on the weight of the plastic film.

The fine particle may be added to the plastic film from the viewpoint of the improvement of scratch resistance. The addition of the fine particle may be carried out in the polymerization stage or in the film-forming stage. The fine particle may be added to the coating liquid for forming the semi-transmitting reflection layer.

The plastic film may be incorporated with additives such as stabilizers, ultraviolet absorbers, flame retardants and antistatic agents.

Preferable antistatic agents are surfactant-type antistatic agents comprising cationic antistatic agents such as quaternary ammonium salt, pyridinium salt and primary to tertiary amino group, anionic antistatic agents such as sulfonic acid base, nitric acid ester base and phosphoric acid ester base, ampholytic antistatic agents such as amino acid-type agents and aminosulfuric acid ester-type agents, and nonionic surfactants such as amino alcohol-type, glycerol-type and polyethylene glycol-type surfactants. Antistatic agents produced by polymerizing the above agents are also preferable.

Electrically conductive polymers such as polyaniline, polypyrrole and polythiophene and dispersions of oxide fillers such as tin oxide and antimony oxide are also usable as the antistatic agent.

The additives may be added in the polymerization stage of the plastic raw material or in the film-forming stage of the plastic film.

The thickness of the plastic film is preferably from 5 to 125 μm, further preferably from 15 to 75 μm to keep the strength necessary as the substrate for the semi-transmitting reflection layer. The plastic film may be a single layer film or a multilayer film. In the case of a multilayer film, an arbitrary number of layers can be formed by coextrusion or lamination.

An antistatic layer may be formed on the plastic film. A layer of a metal such as silver and tin is suitable as the antistatic layer. These layers can be formed e.g. by vapor-phase growing method, vacuum evaporation, sputtering and plasma CVD method.

(Semi-Transmitting Teflection Layer)

The semi-transmitting reflection layer is a layer containing a pearlescent pigment and is usually composed of a pearlescent pigment and a binder.

The pearlescent pigment to be used in the present invention is plate mica particles coated with titanium dioxide. The surface coating ratio of the plate mica particle with the titanium dioxide is preferably between 10 to 50%.

The pearlescent pigment preferably has an average particle diameter of from 3 to 60 μm. The term “average particle diameter” means the average value of the maximum diameter of the plate face of the pearlescent pigment. Sufficient reflecting properties cannot be attained when the average particle diameter of the pearlescent pigment is smaller than 3 μm. When the average particle diameter of the pearlescent pigment exceeds 60 μm, the surface smoothness of the semi-transmitting reflection layer is lost and the visibility is lowered.

In the present invention, the pearlescent pigment in the semi-transmitting reflection layer is oriented at an orientation angle of 15 degrees or less relative to the plane of the plastic film. The term “orientation angle” means the average value of the angles between the planes of a definite number of pearlescent pigments and the plane of the plastic film. Concretely, the cross-section of a semi-transmitting reflection film is photographed with a scanning electron microscope (product of JEOL, Ltd., Model JSM-5200), the angles between the plane of pigment particles and the plane surface of the plastic film are measured on 100 pearlescent pigment particles having an average particle diameter of 3 μm or over and the average value of the angles is calculated to obtain the “orientation angle”.

The ratio of pearlescent pigment oriented at an orientation angle of 15 degrees or under relative to the plane of the film surface is preferably 80% or more in the pearlescent pigment included in the semi-transmitting reflection layer. When the ratio is smaller than 80%, high visibility of the liquid crystal display cannot be attained with both transmitting light and reflecting light.

Accordingly, the preferable mode of the present invention includes a semi-transmitting reflection film having a semi-transmitting reflection layer containing a pearlescent pigment on at least one surface of a plastic film, wherein at least 80% of the pearlescent pigment in the semi-transmitting reflection layer is oriented at an orientation angle of 15 degrees or below relative to the plane direction of the plastic film.

The binder to be used in the semi-transmitting reflection layer acts as a bonding agent to support the pearlescent pigment on a plastic film in oriented state and tightly contact the pigment with the surface of the plastic film.

Transparent resins such as thermoplastic resins, thermosetting resins and ultraviolet curing resins can be used as the binder. The thermoplastic resin is, for example, thermoplastic polyester resins, acrylic resins and cellulose resins. Examples of the thermosetting resin are thermosetting acrylic resins, urethane resins, melamine resins and epoxy resins.

The binder may be composed of a single resin or two or more kinds of resins. The binder may be further incorporated with a crosslinking agent. Preferable crosslinking agents are methylolated or alkylolated melamine, urea or acrylamide compounds, epoxy compounds and polyisocyanate compounds.

The weight ratio of the pearlescent pigment to the binder is preferably between 10:90 and 70:30, more preferably between 20:80 and 60:40 to ensure good visibility of the semi-transmitting reflection layer with both transmitting light and reflecting light.

The semi-transmitting reflection layer can be formed by uniformly applying a coating liquid containing a pearlescent pigment, a binder and an organic solvent on the surface of a plastic film and drying the coating layer. The organic solvent is used for the adjustment of the viscosity of the solution. The viscosity of the liquid to form the semi-transmitting reflection layer is preferably 1,000 mPas or below, more preferably 300 mPas or below. The viscosity of the liquid higher than 1,000 mPas is not preferable because the dependency of the orientation of the pearlescent pigment on the shear stress is developed in the process for forming the semi-transmitting reflection layer and the sufficient reflecting light becomes hardly attainable.

The organic solvent is used for controlling the viscosity of the coating liquid for forming the semi-transmitting reflection layer to 1,000 mPas or below. The use of organic solvents having high compatibility with the binder is preferable for the control of the viscosity and hydrocarbons, ketones, alcohols, ethers and esters are usable as the solvent. The organic solvent may be a single solvent or a combination of two or more solvents.

The coating speed is easily increased by using an organic solvent having low boiling point owing to the decrease of the residual solvent in the dried coating film, however, the surface is sometimes roughened to lose the smoothness by the rapid evaporation of the solvent. Accordingly, it is preferable in the present invention to use an organic solvent having low boiling point in combination with an organic solvent having high boiling point at a weight ratio of the low-boiling solvent to the high-boiling solvent of between 20:80 and 90:10. The definitions of the “organic solvent having low boiling point” and the “organic solvent having high boiling point” follows the common classification and the boundary of the solvents is usually about 110° C. to about 200° C. Especially preferable organic solvent is e.g. a mixture of methyl ethyl ketone and toluene.

The thickness of the semi-transmitting reflection layer is preferably from 2 to 38 μm, more preferably from 5 to 15 μm in dried state. When the thickness of the semi-transmitting reflection layer is thinner than 2 μm, the number of superposed pearlescent pigment particles becomes small and sufficient reflecting light is hardly attainable. Furthermore, when the content of the pearlescent pigment is increased for attaining a sufficient reflecting light in the case of a semi-transmitting reflection layer thinner than 2 μm, the undesirable stripe pattern is liable to develop by a slight difference of the coating thickness. Contrary, a semi-transmitting reflection layer thicker than 38 μm is undesirable owing to the poor productivity caused by the prolonged time necessary for the drying of the coating layer in the coating process to decrease the amount of the residual solvent in the coating film and the increased loss of the light transmitting through the semi-transmitting reflection layer to lower the visibility.

The ratio of the average particle diameter (D) of the pearlescent pigment in the semi-transmitting reflection layer to the thickness (T) of the semi-transmitting reflection layer after drying (hereinafter, the ratio may be abbreviated as D/T ratio) is from 1.3 to 30, preferably from 1.35 to 15. When the D/T ratio is smaller than 1.3, the orientation of the pearlescent pigment pigments becomes irregular to cause insufficient visibility with the reflecting light. On the contrary, the film having a D/T ratio exceeding 30 has lowered visibility with transmitting light and reflecting light. The orientation of pearlescent pigment is facilitated by setting the D/T ratio to 1.3 or over and good visibility with transmitting light and reflecting light can be attained without applying a shear stress in the coating process and dispensing with the procedure for the adjustment of the shear rate between the layer thickness adjusting member and the coating liquid layer or the shear rate between the coating liquid supplying member and the plastic sheet.

(Total Light Transmittance and Total Light Reflectance)

The total light transmittance and the total light reflectance of the semi-transmitting reflection film of the present invention satisfy the following conditions. The semi-transmitting reflection film of the present invention can develop good visibility with both transmitting light and reflecting light by satisfying the conditions.

The term “total light transmittance at 550 nm wavelength” means the percentage of the light intensity transmitted through a semi-transmitting reflection film or a laminate for liquid crystal display having the semi-transmitting reflection film to the intensity of incident light of 550 nm wavelength and measured by an ultraviolet-visible light spectrophotometer.

The term “total light reflectance at 550 nm wavelength” means the percentage of the light intensity reflected from a semi-transmitting reflection film or a laminate for a liquid crystal display having the semi-transmitting reflection film to the intensity of incident light of 550 nm wavelength and measured by an ultraviolet-visible light spectrophotometer.

The total light transmittance of the semi-transmitting reflection film of the present invention at 550 nm wavelength is 20% or above, preferably 25% or above. The total light transmittance of 7%, preferably 9% which is the total light transmittance level sufficient for a laminate for liquid crystal display cannot be attained and the achievement of sufficient visibility with transmitting light becomes unsuccessful when a semi-transmitting reflection film having a total light transmittance of smaller than 20% is laminated to a polarizing film to form a laminate for liquid crystal display.

The total light reflectance of the semi-transmitting reflection film at 550 nm wavelength is 40% or above, preferably 50% or above. The total light reflectance of 20% or above, preferably 25% or above which is the total light reflectance level sufficient for a laminate for liquid crystal display cannot be attained and the achievement of sufficient visibility with reflecting light becomes unsuccessful when a semi-transmitting reflection film having a total light reflectance of smaller than 40% is laminated to a polarizing film to form a laminate for liquid crystal display.

The sum of the total light transmittance and the total light reflectance of the semi-transmitting reflection film at 550 nm wavelength is 80% or above, preferably 90% or above. When the sum of the total light transmittance and the total light reflectance is smaller than 80%, laminate for a liquid crystal display produced by laminating the semi-transmitting reflection film to a polarizing film fails in achieving the sum of the total light transmittance and the total light reflectance of 30% or above, preferably 35% or above which is the level sufficient for a laminate for liquid crystal display. When the sum of the total light transmittance and the total light reflectance is smaller than 80%, either the visibility with transmitting light or the visibility with reflecting light becomes poor.

Accordingly, the semi-transmitting reflection film of the present invention preferably has a total light transmittance of 20% or above, a total light reflectance of 40% or above and the sum of the total light transmittance and the total light reflectance of 80% or above at 550 nm wavelength.

A laminate for a liquid crystal display having a total light transmittance of 7% or above, a total light reflectance of 20% or above and the sum of total light transmittance and total light reflectance of 30% or above at 550 nm wavelength can be produced by bonding a polarizing film to the semi-transmitting reflection layer of the semi-transmitting reflection film of the present invention through a tacky adhesive layer.

(Production Method)

The semi-transmitting reflection film of the present invention can be produced by forming a plastic film to be used as the substrate, coating at least one surface of the plastic film with a coating liquid for forming a semi-transmitting reflection layer containing a pearlescent pigment, a binder and an organic solvent for controlling the viscosity of the liquid and drying the coating layer.

The thermoplastic polymer constituting the plastic film is formed to a biaxially drawn film by a conventional method such as successive biaxial drawing method and simultaneous biaxial drawing method. For example in the case of a polyester film, an undrawn film having an intrinsic viscosity of from 0.40 to 1.50 dl/g is produced by drying a polymer, melting at the ordinary extrusion temperature, namely above the melting point (hereinafter referred to as Tm) and below Tm+70° C., extruding the molten polymer through a die (such as T-die and I-die) and quenching the produced filmy molten material on the surface of a rotary chilling drum. The use of electrostatic pinning method comprising the application of electrostatic charge to the filmy molten material is preferable for improving the contact of the filmy molten material with the rotary chilling drum.

The undrawn film produced by the above procedure is drawn under a condition depending upon the glass transition temperature (hereinafter referred to as Tg) of the polymer in longitudinal direction at a draw ratio of from 2 to 6 at a temperature between (Tg−10)° C. and (Tg+70)° C. and successively drawn in lateral direction by 2-5 times to obtain a biaxially drawn film. The drawn film may be again drawn in longitudinal direction and/or lateral direction as necessary. The draw ratio of the longitudinal direction is preferably set to be nearly equal to that of the lateral direction to obtain a biaxially drawn film having improved isotropicity.

The biaxially drawn film may be subjected to heat setting at a temperature between (Tg+70)° C. and (Tm−10)° C. The preferable heat-setting temperature is, for example, 180 to 235° C. for polyethylene terephthalate and 220 to 240° C. for polyethylene-2,6-naphthalenedicarboxylate. The heat-setting time is preferably from 5 to 60 seconds. After the heat-setting treatment, the film may be subjected to thermal relaxation treatment in longitudinal and/or lateral direction at a relaxation ratio of 0.5 to 15% to decrease the thermal shrinkage of the film.

The thickness of the biaxially drawn film obtained by the above method is preferably from 5 μm to 125 μm.

The semi-transmitting reflection layer can be formed by applying a coating liquid for forming a semi-transmitting reflection layer having a viscosity of 1,000 mPas or below, preferably 300 mPas or below, especially preferably from 30 to 250 mPas to at least one surface of the film in the film-forming process before the completion of the crystal orientation or after the film-forming process after completing the crystal orientation of the biaxially drawn polyester film and drying the applied coating liquid. The coating liquid for forming a semi-transmitting reflection layer contains a pearlescent pigment having an average particle diameter of from 3 to 60 μm (having a thickness of usually 10 to 100 nm), a binder and an organic solvent.

The term “before the completion of crystal orientation” includes an undrawn film produced by thermally melting a polyester and forming a film as it is, a uniaxially drawn film obtained by orienting the undrawn film in either longitudinal direction or lateral direction, a biaxially drawn film produced by drawing and orienting the undrawn film in both longitudinal direction and lateral direction at a low draw ratio (a biaxially drawn film before completing the orientation crystallization by the final redrawing in longitudinal direction or lateral direction) and the like. In the ordinary process, it is preferable to uniformly apply a coating liquid for forming a semi-transmitting reflection layer obtained by dissolving or dispersing a pearlescent pigment and a binder in an organic solvent to a film uniaxially drawn in longitudinal direction.

Conventional coating methods can be used for the coating of the plastic film surface with the above coating liquid. Examples of the coating methods are lip direct coating method, comma coater method, slit reverse method, die coater method, gravure roll coater method, blade coater method, spray coater method, air knife coating method and dip coating method.

In the case of using a thermosetting resin as the binder, the semi-transmitting reflection layer is formed by applying a coating liquid containing individual addition components to a plastic film and drying the liquid with heat to form a uniform coating film. The heat drying conditions are preferably at 80 to 160° C. for 10 to 120 seconds, more preferably at 100 to 150° C. for 20 to 60 seconds.

In the case of using an ultraviolet (UV) curable resin as the bonder, the coating film is produced by radiating ultraviolet rays generally after preparatorily drying the resin.

The coating of the polyester film with the coating liquid is carried out in a manner to set the thickness of dried semi-transmitting reflection layer to 2 to 38 μm, the thickness of the semi-transmitting reflection film to 7 to 163 μm and the ratio of the average particle diameter (D) of the pearlescent pigment to the thickness (T) of the dried semi-transmitting reflection layer (D/T) to between 1.3 and 30. The film is preferably subjected as necessary to physical surface treatment such as flame treatment, corona discharge treatment and plasma discharge treatment or chemical surface treatment comprising the application of an organic resin coating material or inorganic resin coating material during or after the film-forming process as a preparatory treatment for improving the adhesiveness and coating performance.

(Calendering Treatment)

The semi-transmitting reflection film of the present invention preferably has a specular glossiness of from 13 to 70%, more preferably from 20 to 40% as 60 degree specular glossiness. The film having such specular glossiness has a surface texture having silky luster.

Such glossiness can be attained by drying the applied coating liquid for forming a semi-transmitting reflection layer and calendering the product. A semi-transmitting reflection film having a ratio of the 60 degree specular glossiness (A) before calendering to the 60 degree specular glossiness (B) after the calendering treatment (B/A) of preferably 1.3 or over, more preferably 1.5 or over can be produced by the calendering treatment under the conditions of the present invention.

The calendering treatment is carried out under a linear pressure of preferably from 2.5×10⁴ to 1×10⁶ N/m, more preferably from 1×10⁵ to 8×10⁵ N/m. When the linear pressure is smaller than 2.5×10⁴ N/m, the effect of the calendering treatment becomes insufficient to attain little improvement of glossiness and, when the linear pressure exceeds 1×10⁶ N/m, breakage of the semi-transmitting reflection layer and the pearlescent pigment takes place to decrease the visibility with transmitting light and reflecting light.

The surface temperature of the calender roll in the calendering treatment is preferably from 30 to 150° C., more preferably from 50 to 100° C. When the surface temperature of the calender roll is lower than 30° C., the effect of the calendering treatment becomes insufficient to cause little improvement of the glossiness and, when the temperature is higher than 150° C., the semi-transmitting reflection layer is fallen off owing to the increased elongation difference between the semi-transmitting reflection layer and the film. The speed of the calendering treatment is preferably from 2 to 150 m/min, more preferably from 5 to 100 m/min. The productivity is remarkably lowered at a speed of smaller than 2 m/min, and the effect of the calendering treatment becomes poor to cause little improvement of glossiness when the speed exceeds 150 m/min.

The surface roughness of the semi-transmitting reflection layer can be improved by the calendering treatment to 400 nm or below in terms of center line average height (Ra) and 6,000 nm or below in terms of ten-point-average surface roughness (Rz) measured by a three-dimensional contact-type surface roughness tester.

Conventional calendering machine can be used for the calendering treatment. The number of rolls is generally 2 to 5 and the type of the calendering machine is vertical type, horizontal type, inclined type, serial type, L-type, inverted L-type, Z-type, S-type, M-type and others.

(Tacky Adhesive Layer)

The semi-transmitting reflection film of the present invention may be provided with a tacky adhesive layer on the surface of the semi-transmitting reflection layer. The semi-transmitting reflection film can be bonded to a liquid crystal display or a back light composed of a polarizing film, etc., by the application of the tacky adhesive layer. The tacky adhesive constituting the tacky adhesive layer is preferably an acrylic, a rubber or a urethane-based adhesive.

The thickness of the tacky adhesive layer is preferably from 0.5 to 60 μm, more preferably from 2 to 40 μm. The use of a tacky adhesive layer having a thickness falling within the above range is effective for getting sufficient adhesive force without generating the squeeze-out of the adhesive from the edge, facilitating the winding of the film and keeping good handleability in the production process of the film.

The tacky adhesive layer can be formed by conventional coating method after applying a semi-transmitting reflection layer on a plastic film and drying the applied layer. As an alternative, a tacky adhesive layer is formed on a releasing film, pasting the releasing film to a semi-transmitting reflection layer of a semi-transmitting reflection film and peeling the releasing film to transfer the tacky adhesive layer on the surface of the semi-transmitting reflection layer.

The tacky adhesive layer may be applied to the polarizing film by conventional coating method. The semi-transmitting reflection film is laminated to the polarizing film through the tacky adhesive layer to form a laminate for liquid crystal display as the final product.

Any conventional coating methods can be used for the application of the tacky adhesive layer. Examples of the coating methods are kiss coating method, bar coating method, die coating method, reverse coating method, offset gravure coating method, Meyer bar coating method, gravure coating method, roll brushing method, spray coating method, air knife coating method, impregnation method, curtain coating method or their combination.

(Hard Coat Layer)

The semi-transmitting reflection film of the present invention may have a hard coat layer on the surface of the plastic film side. The use of the hard coat layer is effective for preventing the damage of the semi-transmitting reflection film in the course of the storage or transportation of stacked intermediate product composed of a semi-transmitting reflection film bonded to a liquid crystal display part or a back light part and improving the yield of the final product.

Silane-based materials and radiation-curable materials for hard coating are examples of the materials usable in the hard coat layer. Radiation-curable materials for hard coating are preferable among the above materials and ultraviolet (UV) curable materials are especially preferable. Examples of the ultraviolet (UV) curable materials for hard coating are urethane-acrylate, epoxy-acrylate and polyester-acrylate compounds.

The application of a hard coat layer on a semi-transmitting reflection film is performed by applying a material for forming a hard coat layer to the plastic film-side surface of the semi-transmitting reflection film and curing the material by heating, exposure to radiation (for example, ultraviolet rays), etc.

In the case of applying a hard coat layer, the thickness of the hard coat layer is preferably from 0.5 to 10 μm, more preferably from 1 to 5 μm. When the thickness of the hard coat layer is thinner than 0.5 μm, the protection of the intermediate product becomes insufficient and, when the thickness exceeds 10 μm, the undesirable blocking trouble is liable to occur owing to the insufficient cure of the material with heat or radiation.

In the case of applying a hard coat layer, the plastic film is coated with the material for hard coating after applying a semi-transmitting reflection layer and a tacky adhesive layer to the film and the applied hard coating material is cured. Known coating methods can be used for the application of the material for hard coating. Examples of the coating method are kiss coating method, bar coating method, die coating method, reverse coating method, offset gravure coating method, Meyer bar coating method, gravure coating method, roll brushing method, spray coating method, air knife coating method, impregnation method, curtain coating method or their combination.

Effect of the Invention

A semi-transmitting reflection film having excellent visibility with transmitting light and reflecting light and suitable for the use in a liquid crystal display device is provided by the present invention.

A semi-transmitting reflection film having excellent scratch resistance in production, exhibiting excellent texture and suitable for the use in a liquid crystal display device is provided by the present invention.

The present invention further provides a method for the production of a laminate for liquid crystal display comprising the production of a semi-transmitting reflection film and the pasting of a polarizing film on the semi-transmitting reflection layer of the semi-transmitting film through a tacky adhesive layer.

A liquid crystal display panel having excellent visibility with transmitting light as well as reflecting light can be produced from the semi-transmitting reflection polarizing film laminate composed of the semi-transmitting reflection film of the present invention and a polarizing film by laminating the laminate, a liquid crystal member filled with a TN (twisted nematic) liquid crystal and a polarizing film to be placed at the opposite side of the semi-transmitting reflection polarizing film laminate interposing the liquid crystal member therebetween in the order.

### EXAMPLES

The present invention is described in detail by the following examples. The term “part” used in the examples is “parts by weight”. The properties were measured by the following methods.

(1) Thickness (T) of a Semi-Transmitting Reflection Layer

A semi-transmitting reflection film was cut in the direction perpendicular to the film surface and the thickness of the semi-transmitting reflection layer was measured by photographing the cross-section with a scanning electron microscope (product of JEOL, Ltd., Model JSM-5200).

(2) Viscosity of the Coating Liquid

The viscosity of the coating liquid at 25° C. was measured by using a Brookfield viscometer (product of Tokyo Keiki Co., type B8M viscometer). The rotors used in the measurement were Rotor No. 1 for the viscosity of smaller than 100 mPas, Rotor No. 2 for the viscosity of 100 mPas or above and smaller than 200 mPas, Rotor No. 3 for the viscosity of 200 mPas or above and smaller than 500 mPas and Rotor No. 4 for the viscosity of 500 mPas or above.

(3) Orientation Angle of the Pearlescent Pigment

The cross-section of a semi-transmitting reflection film was photographed by a scanning electron microscope (product of JEOL, Ltd., Model JSM-5200), the angles between the flat face of the pearlescent pigment particles and the surface of the plastic film were measured on 100 pearlescent pigment particles having an average particle diameter of 3 μm or over and the measured angles were averaged to obtain the orientation angle.

(4) The Ratio of Oriented Pearlescent Pigment

In the measurement (3) performed on 100 pearlescent pigment particles, the ratio of the number of pearlescent pigment particles having the orientation angle of 15 degrees or below was expressed by percentage and the ratio was evaluated by the following criterion.

◯: Not less than 80% of the pearlescent pigment pigments have the orientation angle of 15 degrees or below.

×: Less than 80% of the pearlescent pigment particles have the orientation angles of 15 degrees or below.

(5) Total Light Transmittance and Total Light Reflectance

The total light transmittance and total light reflectance were measured at 550 nm wavelength by using an ultraviolet visible light spectrophotometer (product of Shimadzu Corp.; Model UV-3101PC). The measurements were performed on both a semi-transmitting reflection film and a semi-transmitting reflection polarizing film laminate produced by laminating a semi-transmitting reflection film to a polarizing film (product of Sanritz Corp.; LL-82-18).

(6) Visibility with Transmitting Light and Visibility with Reflecting Light

The visibility was measured by using a liquid crystal display panel composed of a semi-transmitting reflection polarizing film laminate produced by laminating a semi-transmitting reflection film to a polarizing film, a liquid crystal member filled with TN (twisted nematic) liquid crystal and a polarizing film placed at the side opposite to the semi-transmitting reflection polarizing film laminate interposing the liquid crystal member therebetween. The visibility with transmitting light was measured by displaying an arbitrary pattern on the liquid crystal display panel with a 5W organic electroluminescence element (EL) placed at the back of the liquid crystal display panel. The visibility with reflecting light was measured by displaying an arbitrary pattern on the liquid crystal display panel by irradiating the panel with a 40W fluorescent lamp slantly downward at an angle of 45 degree. The visibility of the displayed pattern with transmitting light or reflecting light was evaluated by the following criterion.

◯: the pattern is easily discernible by visual observation

×: the pattern is hardly discernible by visual observation

(7) Evaluation of Scratch Resistance

An acrylic adhesive (product of Toyo Ink Mfg. Co., Ltd.; Oribain BPS3233D) was diluted with methyl ethyl ketone and applied to the surface of a polarizing film (product of Sanritz Corp.; LL-82-18) with a gravure coater and dried at 130° C. for 2 minutes to obtain a tacky adhesive layer of 5 μm thick. The polarizing film having the tacky adhesive layer was pasted on the semi-transmitting reflection layer of a semi-transmitting reflection film to obtain a semi-transmitting reflection polarizing film laminate. A test piece was produced from the obtained semi-transmitting reflection polarizing film laminate by punching the laminate in the form of a square having a side length of 100 mm. Ten (10) test pieces were stacked at the center of a vessel having a bottom of 120 mm square and a height of 50 mm. The vessel was horizontally reciprocated 5 times over a distance of 100 mm at an acceleration of 0.1 m/sec² while keeping the stacked specimens. The scratch of the test pieces was visually evaluated by the following criterion.

◯: no scratch damage was observable

×: scratch damage was observable

(8) The 60 Degree Specular Glossiness

The 60 degree specular glossiness of the surface of the semi-transmitting reflection layer on the semi-transmitting reflection film was measured by a gloss meter (product of Nippon Denshoku Ind. Co., Ltd.; VGS-SENSOR) in conformity with JIS K7105 1981 “Testing methods for optical properties of plastics”.

### Example 1

A coating liquid for forming a semi-transmitting reflection layer was prepared by adding methyl ethyl ketone to 60 parts of a polyester resin (product of Hitachi Chemical Co., Ltd.; Esper 1510: used as a binder of the semi-transmitting reflection layer) and 40 parts of a pearlescent pigment (product of Merck Ltd., Japan; Iriodin #123: having an average particle diameter of 20 μm and a thickness of about 60 to 170 nm) to disperse the pigment and controlling the viscosity of the liquid to 200 mPas by adding a mixed solvent composed of 50 parts of methyl ethyl ketone and 50 parts of toluene. The coating liquid was applied to a surface of a biaxially drawn polyethylene terephthalate film (product of Teijin DuPont Films Ltd.; Tetoron Film G2-38 μm) with a comma coater and dried at 130° C. for 1 minute to obtain a semi-transmitting reflection film having a semi-transmitting reflection layer of 8 μm thick. The ratio of the average particle diameter (D) of the pearlescent pigment in the semi-transmitting reflection layer to the thickness (T) of the dried layer (D/T) was 2.5. Separately, an acrylic adhesive (product of Toyo Ink Mfg. Co., Ltd.; Oribain BPS3233D) was diluted with methyl ethyl ketone and applied to the surface of a release film (product of Teijin Ltd.; Purex Film S31) with a gravure coater and dried at 130° C. for 2 minutes to obtain a tacky adhesive layer of 5 μm thick. The release film having the tacky adhesive layer was pasted to the surface of the semi-transmitting reflection layer of the semi-transmitting reflection film and peeled to obtain a semi-transmitting reflection film having a tacky adhesive layer on the semi-transmitting reflection layer. A semi-transmitting reflection polarizing film laminate was produced by pasting the obtained semi-transmitting reflection film having the tacky adhesive layer to a polarizing film (product of Sanritz Corp.; LL-82-18).

A liquid crystal display panel was produced from the semi-transmitting reflection polarizing film laminate, a liquid crystal member filled with a TN liquid crystal and a polarizing film placed at the side opposite to the semi-transmitting reflection polarizing film laminate interposing the liquid crystal member therebetween. The characteristics of the obtained semi-transmitting reflection film, semi-transmitting reflection polarizing film laminate and liquid crystal display panel are shown in the Table 1.

### Example 2

A coating liquid for forming a semi-transmitting reflection layer was prepared by adding methyl ethyl ketone to 75 parts of a polyester resin (product of Hitachi Chemical Co., Ltd.; Esper 1510) and 25 parts of a pearlescent pigment (product of Merck Ltd., Japan; Iriodin #123: having an average particle diameter of 20 μm) to disperse the pigment and controlling the viscosity of the liquid to 200 mPas by adding a mixed solvent composed of 50 parts of methyl ethyl ketone and 50 parts of toluene. The coating liquid was applied to a surface of a biaxially drawn polyethylene terephthalate film (product of Teijin DuPont Films Ltd.; Tetoron Film G2-38 μm) with a comma coater and dried at 130° C. for 1 minute to obtain a semi-transmitting reflection film having a semi-transmitting reflection layer of 14 μm thick. The ratio of the average particle diameter (D) of the pearlescent pigment in the semi-transmitting reflection layer to the thickness (T) of the dried layer (D/T) was 1.4. A semi-transmitting reflection polarizing film laminate and a liquid crystal display panel were produced by the method similar to the Example 1 using the obtained semi-transmitting reflection film. The characteristics of the obtained semi-transmitting reflection film, semi-transmitting reflection polarizing film laminate and liquid crystal display panel are shown in the Table 1.

### Example 3

A coating liquid for forming a semi-transmitting reflection layer was prepared by adding methyl ethyl ketone to 40 parts of a polyester resin (product of Hitachi Chemical Co., Ltd.; Esper 1510) and 60 parts of a pearlescent pigment (product of Merck Ltd., Japan; Iriodin #123: having an average particle diameter of 20 μm) to disperse the pigment and controlling the viscosity of the liquid to 200 mPas by adding a mixed solvent composed of 50 parts of methyl ethyl ketone and 50 parts of toluene. The coating liquid was applied to a surface of a biaxially drawn polyethylene terephthalate film (product of Teijin DuPont Films Ltd.; Tetoron Film G2-38 μm) with a comma coater and dried at 130° C. for 1 minute to obtain a semi-transmitting reflection film having a semi-transmitting reflection layer of 5 μm thick. The ratio of the average particle diameter (D) of the pearlescent pigment in the semi-transmitting reflection layer to the thickness (T) of the dried layer (D/T) was 4.0. A semi-transmitting reflection polarizing film laminate and a liquid crystal display panel were produced by the method similar to the Example 1 using the obtained semi-transmitting reflection film. The characteristics of the obtained semi-transmitting reflection film, semi-transmitting reflection polarizing film laminate and liquid crystal display panel are shown in the Table 1.

### Example 4

A semi-transmitting reflection film having a semi-transmitting reflection layer of 8 μm thick was produced in the same way as the Example 1 except that the pearlescent pigment having an average particle diameter of 50 μm was used in the production. The ratio of the average particle diameter (D) of the pearlescent pigment in the semi-transmitting reflection layer to the thickness (T) of the dried layer (D/T) was 6.3. A semi-transmitting reflection polarizing film laminate and a liquid crystal display panel were produced by the method similar to the Example 1 using the obtained semi-transmitting reflection film. The characteristics of the obtained semi-transmitting reflection film, semi-transmitting reflection polarizing film laminate and liquid crystal display panel are shown in the Table 1.

### Example 5

A coating liquid for forming a semi-transmitting reflection layer was prepared by adding methyl ethyl ketone to 75 parts of a polyester resin (product of Hitachi Chemical Co., Ltd.; Esper 1510) and 25 parts of a pearlescent pigment (product of Merck Ltd., Japan; Iriodin #123: having an average particle diameter of 20 μm) to disperse the pigment and controlling the viscosity of the liquid to 80 mPas by adding a mixed solvent composed of 50 parts of methyl ethyl ketone and 50 parts of toluene. The coating liquid was applied to a surface of a biaxially drawn polyethylene terephthalate film (product of Teijin DuPont Films Ltd.; Tetoron Film G2-38 μm) with a comma coater and dried at 130° C. for 1 minute to obtain a semi-transmitting reflection film having a semi-transmitting reflection layer of 10 μm thick. The ratio of the average particle diameter (D) of the pearlescent pigment in the semi-transmitting reflection layer to the thickness (T) of the dried layer (D/T) was 2.0. A semi-transmitting reflection polarizing film laminate and a liquid crystal display panel were produced by the method similar to the Example 1 using the obtained semi-transmitting reflection film. The characteristics of the obtained semi-transmitting reflection film, semi-transmitting reflection polarizing film laminate and liquid crystal display panel are shown in the Table 1.

### Comparative Example 1

A semi-transmitting reflection film was produced in the same way as the Example 2 except that the thickness of the semi-transmitting reflection layer was set to 20 μm. The D/T ratio of the semi-transmitting reflection layer was 1.0. A semi-transmitting reflection polarizing film laminate and a liquid crystal display panel were produced in the same way as the Example 1 using the obtained semi-transmitting reflection film. The shear rate at the application of the coating liquid for forming a semi-transmitting reflection layer to the biaxially drawn polyethylene terephthalate film was 1.25μ10⁶ sec⁻¹. The characteristics of the obtained semi-transmitting reflection film, semi-transmitting reflection polarizing film laminate and liquid crystal display panel are shown in the Table 1.

### Comparative Example 2

A semi-transmitting reflection film was produced in the same was as the Comparative Example 1 except that the coating was carried out with a reverse coater at a shear rate of 3×10⁴ sec⁻¹ between the biaxially drawn polyethylene terephthalate film and the applicator roll. The D/T ratio of the semi-transmitting reflection layer was 1.0. A semi-transmitting reflection polarizing film laminate and a liquid crystal display panel were produced by the method similar to the Example 1 using the obtained semi-transmitting reflection film. The characteristics of the obtained semi-transmitting reflection film, semi-transmitting reflection polarizing film laminate and liquid crystal display panel are shown in the Table 1.

Comparative Example 3

A semi-transmitting reflection film was produced in the same was as the Comparative Example 1 except that the coating was carried out with a reverse coater at a shear rate of 3×10⁴ sec⁻¹ between the biaxially drawn polyethylene terephthalate film and the applicator roll and the thickness of the semi-transmitting reflection layer was set to 40 μm. The D/T ratio of the semi-transmitting reflection layer was 0.5. A semi-transmitting reflection polarizing film laminate and a liquid crystal display panel were produced by the method similar to the Example 1 using the obtained semi-transmitting reflection film. The characteristics of the obtained semi-transmitting reflection film, semi-transmitting reflection polarizing film laminate and liquid crystal display panel are shown in the Table 1.

### Comparative Example 4

A semi-transmitting reflection film having a semi-transmitting reflection layer of 8 μm thick was produced in the same way as the Example 1 except that methyl ethyl ketone was added to 60 parts of a polyester resin (product of Hitachi Chemical Co., Ltd.; Esper 1510) and 40 parts of a pearlescent pigment (product of Merck Ltd., Japan; Iriodin #123: having an average particle diameter of 20 μm) to disperse the pigment and the viscosity of the liquid was controlled to 1500 mPas by adding a mixed solvent composed of 50 parts of methyl ethyl ketone and 50 parts of toluene. The D/T ratio of the semi-transmitting reflection layer was 2.5. A semi-transmitting reflection polarizing film laminate and a liquid crystal display panel were produced by the method similar to the Example 1 using the obtained semi-transmitting reflection film. The characteristics of the obtained semi-transmitting reflection film, semi-transmitting reflection polarizing film laminate and liquid crystal display panel are shown in the Table 1.

Comparative Example 5

A semi-transmitting reflection film having a semi-transmitting reflection layer of 20 μm thick was produced in the same way as the Example 1 except that methyl ethyl ketone was added to 60 parts of a polyester resin (product of Hitachi Chemical Co., Ltd.; Esper 1510) and 40 parts of a pearlescent pigment (product of Merck Ltd., Japan; Iriodin #123: having an average particle diameter of 20 μm) to disperse the pigment and the viscosity of the liquid was controlled to 1500 mPas by adding a mixed solvent composed of 50 parts of methyl ethyl ketone and 50 parts of toluene. The D/T ratio of the semi-transmitting reflection layer was 1.0. A semi-transmitting reflection polarizing film laminate and a liquid crystal display panel were produced by the method similar to the Example 1 using the obtained semi-transmitting reflection film. The characteristics of the obtained semi-transmitting reflection film, semi-transmitting reflection polarizing film laminate and liquid crystal display panel are shown in the Table 1.

### Comparative Example 6

A semi-transmitting reflection film was produced in the same way as the Example 5 except that the thickness of the semi-transmitting reflection layer was set to 20 μm. The ratio of the average particle diameter (D) of the pearlescent pigment in the semi-transmitting reflection layer to the thickness (T) of the dried semi-transmitting reflection layer (D/T) was 1.0. A semi-transmitting reflection polarizing film laminate and a liquid crystal display panel were produced in the same way as the Example 1 using the obtained semi-transmitting reflection film. The characteristics of the obtained semi-transmitting reflection film, semi-transmitting reflection polarizing film laminate and liquid crystal display panel are shown in the Table 1.

TABLE 1

| | | | | | | visibility | semi-transmitting reflection | | semi-transmitting reflecting | |
|---|---|---|---|---|---|---|---|---|---|---|
| | | | orien- | ratio of | visibility with | with | film | | polarizing film laminate | |
| | | | | | | | total | total | | |
| | | viscosity | tation | pearlescent | transmitting | reflecting | light trans- | total light | light trans- | total light |
| | D/T | (mPas) | angle (*) | pigment | light | light | mittance (%) | reflectance (%) | mittance (%) | relfectance (%) |
| Exam- | 2.5 | 200 | 5 | ◯ | ◯ | ◯ | 30 | 65 | 10 | 27 |
| ple 1 | | | | | | | | | | |
| Exam- | 1.4 | 200 | 6 | ◯ | ◯ | ◯ | 23 | 71 | 8 | 30 |
| ple 2 | | | | | | | | | | |
| Exam- | 4.0 | 200 | 3 | ◯ | ◯ | ◯ | 34 | 61 | 11 | 26 |
| ple 3 | | | | | | | | | | |
| Exam- | 6.3 | 200 | 7 | ◯ | ◯ | ◯ | 28 | 67 | 9 | 28 |
| ple 4 | | | | | | | | | | |
| Exam- | 2.0 | 80 | 5 | ◯ | ◯ | ◯ | 29 | 66 | 10 | 28 |
| ple 5 | | | | | | | | | | |
| Com- | 1.0 | 200 | 36 | X | ◯ | X | 51 | 32 | 22 | 10 |
| parative | | | | | | | | | | |
| Exam- | | | | | | | | | | |
| ple 1 | | | | | | | | | | |
| Com- | 1.0 | 200 | 35 | X | ◯ | X | 50 | 34 | 21 | 11 |
| parative | | | | | | | | | | |
| Exam- | | | | | | | | | | |
| ple 2 | | | | | | | | | | |
| Com- | 0.5 | 200 | 40 | X | X | ◯ | 13 | 70 | 4 | 30 |
| parative | | | | | | | | | | |
| Exam- | | | | | | | | | | |
| ple 3 | | | | | | | | | | |
| Com- | 2.5 | 1500 | 33 | X | ◯ | X | 43 | 35 | 17 | 11 |
| parative | | | | | | | | | | |
| Exam- | | | | | | | | | | |
| ple 4 | | | | | | | | | | |
| Com- | 1.0 | 1500 | 37 | X | X | ◯ | 14 | 69 | 4 | 28 |
| parative | | | | | | | | | | |
| Exam- | | | | | | | | | | |
| ple 5 | | | | | | | | | | |
| Com- | 1.0 | 80 | 38 | X | ◯ | X | 44 | 33 | 18 | 11 |
| parative | | | | | | | | | | |
| Exam- | | | | | | | | | | |
| ple 6 | | | | | | | | | | |

It is clear from the Table 1 that, in the semi-transmitting reflection film of each Example, the viscosity of the coating liquid for forming the semi-transmitting reflection layer was 1,000 mPas or below, the D/T ratio was 1.3 or over, the ratio of the pearlescent pigment having an orientation angle of 15 degrees or smaller was 80% or over and the pearlescent pigment was oriented parallel to the plane of the plastic film and, accordingly, all semi-transmitting reflection films and semi-transmitting reflection layer polarizing film laminates satisfied the requirements on total light transmittance and total light reflectance to give liquid crystal display panels having good visibility with transmitting light and visibility with reflecting light.

On the contrary, although the viscosity of the coating liquid forming the semi-transmitting reflection layer was 1,000 mPa or below in both of the Comparative Examples 1 and 2, the orientation angle of the pearlescent pigment was large independent of the shear rate and the orientation of the pearlescent pigment was insufficient because the D/T ratio of the layer was smaller than 1.3. Although the D/T ratio of the Comparative Example was also smaller than 1.3 similar to the Comparative Examples 1 and 2, the reflection characteristic was improved by increasing the thickness of the semi-transmitting reflection layer. However, owing to the insufficient orientation of the pearlescent pigment, the loss of light was increased according to the increase of the thickness to deteriorate the total light transmittance and the visibility with transmitting light.

The D/T ratio of the Comparative Example was not smaller than 1.3, however, the orientation of pearlescent pigment was insufficient because the viscosity of the coating liquid for forming the semi-transmitting reflection layer was larger than 1,000 mPas and the total light transmittance was insufficient in both of the semi-transmitting reflection film and the semi-transmitting reflection polarizing film laminate to deteriorate the reflecting light visibility of the liquid crystal display panel. The orientation of the pearlescent pigment was insufficient in the Comparative Example 5 because the D/T ratio was smaller than 1.3 and the viscosity of the coating liquid for forming the semi-transmitting reflection layer was larger than 1,000 mPas, however, the visibility with reflecting light was improved by increasing the thickness of the semi-transmitting reflection layer. When the visibility with reflecting light was increased to a satisfactory range by increasing the thickness, the loss of light became large by the insufficient orientation of the pearlescent pigment and the total light transmittance became insufficient for both of the semi-transmitting reflection film and the semi-transmitting reflection polarizing film laminate to deteriorate the transmitting light visibility of the liquid crystal display panel.

The viscosity of the coating liquid for forming the semi-transmitting reflection layer of the Comparative Example 6 was also not larger than 1,000 mPas similar to the Comparative Examples 1 and 2, however, the orientation angle of the pearlescent pigment became large owing to the D/T ratio smaller than 1.3 and sufficient orientation was unattainable. As a result, the total light reflectance was insufficient for both of the semi-transmitting reflection film and the semi-transmitting reflection polarizing film laminate and the visibility of the liquid crystal display panel with reflecting light became poor.

### Example 6

A coating liquid for forming a coating film having semi-transmitting reflection function was prepared by adding methyl ethyl ketone to 60 parts of a polyester resin (product of Hitachi Chemical Co., Ltd.; Esper 1510) and 40 parts of a pearlescent pigment (product of Merck Ltd., Japan; Iriodin #123: having an average particle diameter of 20 μm) to disperse the pigment and controlling the viscosity of the liquid to 200 mPas by adding a mixed solvent composed of 50 parts of methyl ethyl ketone and 50 parts of toluene.

The coating liquid was applied to a surface of a biaxially drawn polyester film (product of Teijin DuPont Films Ltd.; Tetoron Film U4-38 μm) with a comma coater and dried at 130° C. for 1 minute to obtain a semi-transmitting reflection film having a coating layer of 4 μm thick. The biaxially drawn polyester film used in the above process had a center line average height (Ra) of 300 nm and a ten-point-average surface roughness (Ra) of 4,300 nm. The characteristics of the obtained semi-transmitting reflection film are shown in the Table 2.

### Comparative Example 7

A semi-transmitting reflection film was produced in the same way as the Example 1 except that the biaxially drawn polyester film was changed to the Tetoron Film E2-62 μm manufactured by Teijin DuPont Films Ltd., and the thickness of the dried coating film layer was changed to 8 μm. The biaxially drawn polyester film used in the above process had a center line average height (Ra) of 10 nm and a ten-point-average surface roughness (Rz) of 130 nm. The characteristics of the obtained semi-transmitting reflection film are shown in the Table 2.

### Comparative Example 8

A semi-transmitting reflection film was produced in the same way as the Example 1 except that the biaxially drawn polyester film was changed to the Tetoron Film O-100 μm manufactured by Teijin DuPont Films Ltd., and the thickness of the dried coating film layer was changed to 8 μm. The biaxially drawn polyester film used in the above process had a center line average height (Ra) of 7 nm and a ten-point-average surface roughness (Rz) of 160 nm. The characteristics of the obtained semi-transmitting reflection film are shown in the Table 2.

TABLE 2

| | | | | | | | | semi-transmitting | |
|---|---|---|---|---|---|---|---|---|---|
| | | | | Visibility | Visibility | semi-transmitting | | reflection polarizing film | |
| | | | | with | with | reflection film | | laminate | |
| | | | | | | total | total | total | total |
| | | | Scratch | transmitting | reflecting | light trans- | light | light trans- | light |
| | Ra (nm) | Rz (nm) | resistance | light | light | mittance (%) | reflectance (%) | mittance (%) | reflectance (%) |
| Example 6 | 300 | 4300 | ◯ | ◯ | ◯ | 33 | 63 | 11 | 26 |
| Comparative | 10 | 130 | X | ◯ | ◯ | 30 | 65 | 10 | 27 |
| example 7 | | | | | | | | | |
| Comparative | 7 | 160 | X | ◯ | ◯ | 32 | 65 | 11 | 27 |
| Example | | | | | | | | | |

### Example 7

A coating liquid for forming a semi-transmitting reflection layer was prepared by adding methyl ethyl ketone to 55 parts of a nitrocellulose/acrylpolyol resin (product of Dainichiseika Color & Chemicals Mfg. Co., Ltd.; VM-AL), 5 parts of an isocyanate curing agent (product of Dainichiseika; L-8 modification) and 40 parts of a pearlescent pigment (product of Merck Ltd., Japan; Iriodin #123: having an average particle diameter of 20 μm) to disperse the pigment and controlling the viscosity of the liquid to 200 mPas by adding a mixed solvent composed of 50 parts of methyl ethyl ketone and 50 parts of toluene.

The coating liquid was applied to a surface of a biaxially drawn polyester film (product of Teijin DuPont Films Ltd.; Tetoron Film G2-38 μm) with a comma coater and dried at 130 ° C. for 1 minute to obtain a semi-transmitting reflection film having a semi-transmitting reflection layer of 8 μm thick. The semi-transmitting reflection film was calendered with a 5-roll calendering machine under a calendering speed of 10 m/min, a roll temperature of 80° C. and a linear pressure of 2.94×10⁵ N/m to obtain a semi-transmitting reflection film. The characteristics of the obtained semi-transmitting reflection film are shown in the Table 3.

### Example 8

A semi-transmitting reflection film was produced in the same way as the Example 1 except that the calendering treatment was carried out at a calendering speed of 5 m/min, a roll temperature of 80° C. and a linear pressure of 1.96×10⁵ N/m. The characteristics of the obtained semi-transmitting reflection film are shown in the Table 3.

### Comparative Example 9

A coating liquid for forming a semi-transmitting reflection layer was prepared by adding methyl ethyl ketone to 55 parts of a nitrocellulose/acrylpolyol resin (product of Dainichiseika Color & Chemicals Mfg. Co., Ltd.; VM-AL), 5 parts of an isocyanate curing agent (product of Dainichiseika; L-8 modification) and 40 parts of a pearlescent pigment (product of Merck Ltd., Japan; Iriodin #123: having an average particle diameter of 20 μm) to disperse the pigment and controlling the viscosity of the liquid to 200 mPas by adding a mixed solvent composed of 50 parts of methyl ethyl ketone and 50 parts of toluene.

The coating liquid was applied to a surface of a biaxially drawn polyester film (product of Teijin DuPont Films Ltd.; Tetoron Film G2-38 μm) with a comma coater and dried at 130° C. for 1 minute to obtain a semi-transmitting reflection film having a semi-transmitting reflection layer of 8 μm thick. The calendering treatment was not used in this case. The characteristics of the obtained semi-transmitting reflection film are shown in the Table 3.

TABLE 3

| | | | | semi-transmittance reflection | | semi-transmitting reflection | |
|---|---|---|---|---|---|---|---|
| | | | | film | | polarizing film laminate | |
| | 60 degree | | | total light | total light | total light | total light |
| | specular | | | transmittance | reflectance | transmittance | reflectance |
| | gloss (%) | Ra (nm) | Rz (nm) | (%) | (%) | (%) | (%) |
| Example 7 | 22.6 | 330 | 2900 | 28 | 65 | 10 | 27 |
| Comparative | 23.5 | 270 | 2400 | 27 | 66 | 9 | 28 |
| example 8 | | | | | | | |
| Comparative | 12.7 | 650 | 8300 | 29 | 64 | 10 | 27 |
| Example 9 | | | | | | | |

1. A semi-transmitting reflection film having a semi-transmitting reflection layer containing a pearlescent pigment and formed on at least one surface of a plastic film provided that the pearlescent pigment in the semi-transmitting reflection layer is oriented at an orientation angle of 15 degrees or smaller relative to the plane of the plastic film, the average particle diameter of the pearlescent pigment in the semi-transmitting reflection layer is from 3 to 60 μm and the ratio of the average particle diameter (D) of the pearlescent pigment in the semi-transmitting reflection layer to the thickness (T) of the semi-transmitting reflection layer (D/T) is from 1.3 to 30.

2. A semi-transmitting reflection film having a semi-transmitting reflection layer containing a pearlescent pigment and formed on at least one surface of a plastic film provided that at least 80% of the pearlescent pigment in the semi-transmitting reflection layer is oriented at an orientation angle of 15 degrees or smaller relative to the plane of the plastic film.

3. A semi-transmitting reflection film described in the claim 1 or the claim 2, wherein the total light transmittance of the film is 20% or above, the total light reflectance is 40% or above and the sum of the total light transmittance and the total light reflectance is 80% or above at 550 nm wavelength.

4. A semi-transmitting reflection film described in the claim 1 or 2, wherein said film has a semi-transmitting reflection layer on one surface of the plastic film and a hard coat layer on the other surface.

5. A semi-transmitting reflection film described in the claim 1 or 2, wherein a tacky adhesive layer is formed on the semi-transmitting reflection layer.

6. A semi-transmitting reflection film described in the claim 1 or 2, wherein the plastic film is a polyester film.

7. A semi-transmitting reflection film described in the claim 6, wherein the polyester film has a center line average height (Ra) of from 15 to 40 nm.

8. A semi-transmitting reflection film described in the claim 6, wherein the ten-point-average surface roughness (Rz) of the polyester film is from 2,000 to 6,000 nm.

9. A semi-transmitting reflection film described in the claim 6, wherein the polyester film has protrusions having a height of 0.6 μm or higher at a density of 100/mm² or above.

10. A laminate for liquid crystal display produced by pasting a polarizing film on the semi-transmitting reflection layer of the semi-transmitting reflection film described in the claim 1 or 2 through a tacky adhesive layer and having a total light transmittance of 7% or above, a total light reflectance of 20% or above and the sum of the total light transmittance and the total light reflectance of 30% or above at 550 nm wavelength.

11. A method for the production of a semi-transmitting reflection film having a semi-transmitting reflection layer by coating at least one surface of a plastic film with a coating liquid for forming a semi-transmitting reflection layer and drying the coating liquid, wherein the coating liquid for forming a semi-transmitting reflection layer contains a pearlescent pigment having an average particle diameter of from 3 to 60 μm, a binder and an organic solvent and the viscosity of the coating liquid is 1,000 mPas or below.

12. A method for the production of a semi-transmitting reflection film described in the claim 11, wherein a calendering treatment is carried out after the application and drying of the coating liquid for forming a semi-transmitting reflection layer.

13. A method for the production of a semi-transmitting reflection film described in the claim 12, wherein the ratio of the 60 degree specular glossiness (A) before calendering to the 60 degree specular glossiness (B) after calendering (B/A) is 1.3 or over.

14. A method for the production of a semi-transmitting reflection film described in the claim 12, wherein the calendering treatment is carried out under the conditions of a linear pressure of from 2.5×10⁴ to 1×10⁶ N/m, a surface temperature of calender roll of from 30 to 150° C. and a calendering speed of from 2 to 150 m/min.

15. A method for the production of a laminate for liquid crystal display comprising the production of a semi-transmitting reflection film by the method described in the claim 11 and the pasting of a polarizing film on the semi-transmitting reflection layer of the semi-transmitting reflection film through a tacky adhesive layer.
